(19) United States
(12) Patent Application Publication
(10) Pub. No.: US 2016/0278134 A1
(43) Pub. Date: Sep. 22, 2016

(54) METHODS AND SYSTEMS FOR MANAGING A CONNECTION BETWEEN ELECTRONIC DEVICES

(71) Applicant: Noodoe Corporation, Taipei City (TW)

(72) Inventors: Chih-Feng Hsu, Taipei City (TW); Li-Hui Chen, Taipei City (TW)

(21) Appl. No.: 15/062,285

(22) Filed: Mar. 7, 2016

(30) Foreign Application Priority Data
Mar. 17, 2015 (TW) 104108397

(51) Int. Cl. H04W 76/02; H04W 4/00; H04W 52/02; H04W 72/00

(52) U.S. Cl. CPC H04W 76/02; H04W 72/005; H04W 4/008; H04W 52/0209

(57) ABSTRACT

Methods and systems for managing a connection between electronic devices are provided. First, a first electronic device generates a specific signal, wherein the specific signal includes a specific code and identification data corresponding to the first electronic device. The first electronic device wirelessly broadcasts the specific signal. Then, a second electronic device wirelessly receives the specific signal, and determines whether the specific code in the specific signal matches a predefined code. If so, the second electronic device wirelessly connects to the first electronic device according to the identification data in the specific signal.

### BACKGROUND OF THE INVENTION

1. Field of the Invention

The disclosure relates generally to connection management methods and systems, and, more particularly to methods and systems that can drive an electronic device to connect to a specific electronic device according to a request generated by the specific electronic device.

2. Description of the Related Art

With the coming of IOT (Internet Of Things), every type of device or object can connect to a network, and users can access and control these devices or objects via networks. Currently, wearable electronic devices have become the most tangible applications of IOT. In some cases, the wearable device can detect health information of a user, record exercise information and sleep patterns, or display email messages or incoming call notifications.

In order to extend the standby time of wearable electronic devices, related components of wearable electronic devices will adopt a low-power consumption technology. For example, a wearable electronic device may have a wireless connecting unit implemented with a low-power consumption technology, such as Bluetooth Smart technology, for connecting with a smart phone implemented with a compatible low-power consumption technology, such as Bluetooth Smart Ready technology via a wireless network. Conventionally, the low-power consumption wireless connecting unit supports two modes: central and peripheral. In the central mode, the wireless connecting unit can receive data from the wireless connecting units of other electronic devices, and can actively connect to other electronic devices. In the peripheral mode, the wireless connecting unit can broadcast its data. However, the wireless connecting unit cannot actively connect to other electronic devices in the peripheral mode.

Generally, when data needs to be transmitted between electronic devices, such as a smart phone and a wearable electronic device, a smart phone in central mode can actively connect to the wearable electronic device via a wireless network and transmit the data to the wearable electronic device. However, when the wearable electronic device needs to be connected with the smart phone, for example, the wearable electronic device wants to transmit data to the smart phone, or the wearable electronic device wants to perform a specific process with the smart phone, the wearable electronic device cannot actively connect to the smart phone, the wearable electronic device must wait until the smart phone actively connects to the wearable electronic device and perform the data transmission process or any other specific process while connected with the smart phone. Since the connection timing of the smart phone and the wearable electronic device is uncertain, related requirements of the wearable electronic device cannot be transmitted in real-time to the smart phone.

Conventionally, in order to reliably know the requirements of the wearable device in real-time the smart phone must always maintain the connection with the wearable electronic device. Since the timing of the requirement generated by the wearable electronic device is also uncertain, the wearable electronic device cannot be connected to other electronic devices during the connection with the smart phone. The uncertainty of waiting requirements of the wearable electronic device results in difficulties of task scheduling in the smart phone and the wearable electronic device. Additionally, in order to maintain the connection between the smart phone and the wearable electronic device, more system resources, such as power of the smart phone and the wearable electronic device must be consumed.

### BRIEF SUMMARY OF THE INVENTION

Methods and systems for managing a connection between electronic devices are provided, wherein an electronic device can be driven to connect to a specific electronic device according to a request generated by the specific electronic device.

In an embodiment of a method for managing a connection between electronic devices, a first electronic device generates a specific signal, wherein the specific signal includes a specific code and identification data corresponding to the first electronic device. The first electronic device wirelessly broadcasts the specific signal. Then, a second electronic device wirelessly receives the specific signal, and determines whether the specific code in the specific signal matches a predefined code. When the specific code in the specific signal matches the predefined code, the second electronic device wirelessly connects to the first electronic device according to the identification data in the specific signal.

An embodiment of a system for managing a connection between electronic devices comprises a first electronic device and a second electronic device. The first electronic device generates a specific signal, wherein the specific signal includes a specific code and identification data corresponding to the first electronic device. The first electronic device wirelessly broadcasts the specific signal. The second electronic device wirelessly receives the specific signal, and determines whether the specific code in the specific signal matches a predefined code. When the specific code in the specific signal matches the predefined code, the second electronic device wirelessly connects to the first electronic device according to the identification data in the specific signal.

In some embodiments, a wireless connecting unit of the first electronic device is in a peripheral mode, and a wireless connecting unit of the second electronic device is in a central mode. In the peripheral mode, the wireless connecting unit has data broadcasting capabilities, and the wireless connecting unit cannot actively connect to other electronic devices. In the central mode, the wireless connecting unit has data receiving capabilities, and the wireless connecting unit can actively connect to other electronic devices.

In some embodiments, the first electronic device receives an instruction, and generates the specific signal according to the instruction, wherein the first electronic device comprises at least one sensor for detecting a motion or posture corresponding to the first electronic device, and the first electronic device generates the instruction according to the detected motion or posture.

In some embodiments, the first electronic device receives an instruction, and generates the specific signal according to the instruction, wherein the first electronic device comprises at least one physical key, and the first electronic device generates the instruction when the physical key is pressed.

In some embodiments, the first electronic device receives an instruction, and generates a specific signal according to the instruction, wherein the first electronic device determines whether a specific condition is met, and the first electronic device generates the instruction when the specific condition is met. In some embodiments, the first electronic device comprises at least one sensor for detecting an environmental factor, and the first electronic device generates the instruction when the specific condition is met based on the environmental factor.

In some embodiments, after the second electronic device connects to the first electronic device via the wireless network, a data transmission process is performed between the first electronic device and the second electronic device.

Methods for managing a connection between electronic devices may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a system for managing a connection between electronic devices of the invention;

FIG. 2 is a schematic diagram illustrating an embodiment of a first electronic device of the invention;

FIG. 3 is a schematic diagram illustrating an embodiment of a second electronic device of the invention;

FIG. 4 is a flowchart of an embodiment of a method for managing a connection between electronic devices of the invention;

FIG. 5 is a flowchart of another embodiment of a method for managing a connection between electronic devices of the invention;

FIG. 6 is a flowchart of an embodiment of a method for generating a specific signal of the invention;

FIG. 7 is a flowchart of another embodiment of a method for generating a specific signal of the invention; and

FIG. 8 is a flowchart of another embodiment of a method for generating a specific signal of the invention.

### DETAILED DESCRIPTION OF THE INVENTION

Methods and systems for managing a connection between electronic devices are provided.

FIG. 1 is a schematic diagram illustrating an embodiment of a system for managing a connection between electronic devices of the invention. The system for managing a connection between electronic devices 100 comprises a first electronic device 110 and a second electronic device 120. The first electronic device 110 and the second electronic device 120 can be any electronic device having wireless connecting capabilities. The first electronic device 110 can transmit signals via a wireless network 130, such as Wi-Fi or Bluetooth network, and the second electronic device 120 can receive the signals transmitted by the first electronic device 110 via the wireless network 130, and connect to the first electronic device 110 via the wireless network 130.

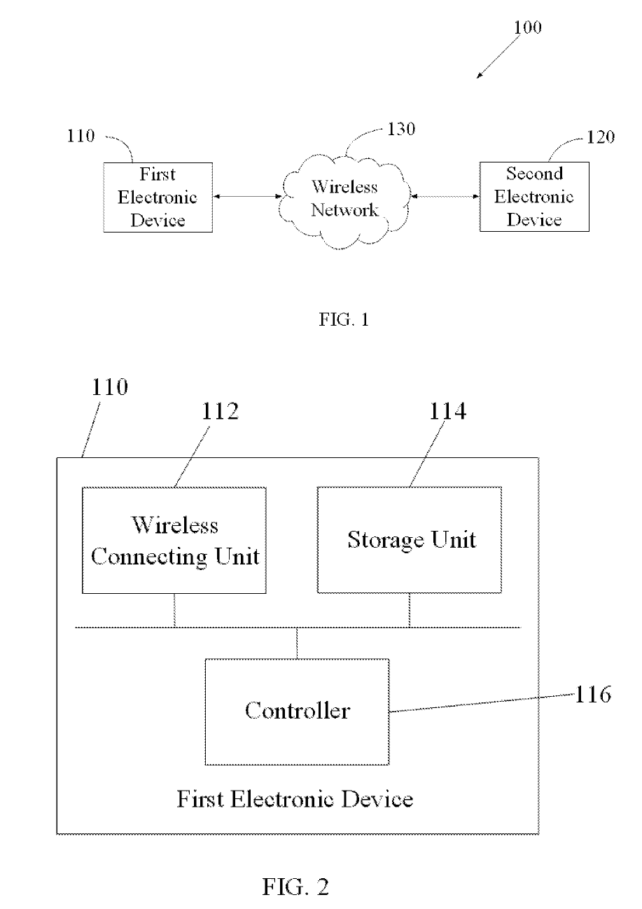

FIG. 2 is a schematic diagram illustrating an embodiment of a first electronic device of the invention. As shown in FIG. 2, the first electronic device 110 comprises a wireless connecting unit 112, a storage unit 114, and a controller 116. The wireless connecting unit 112 can connect to other electronic devices having wireless connecting capabilities via a wireless network, such as Wi-Fi or Bluetooth network. It is understood that, in some embodiments, the wireless connecting unit 112 may be a wireless connecting unit implemented with a low-power consumption technology, such as Bluetooth Smart technology. The Bluetooth Smart technology supports two modes: central and peripheral. In the central mode, the wireless connecting unit can receive data from the wireless connecting units of other electronic devices, and can actively connect to other electronic devices. In the peripheral mode, the wireless connecting unit can broadcast signals, such as its identification data. However, the wireless connecting unit cannot actively connect to other electronic devices in the peripheral mode. In some embodiments, the wireless connecting unit 112 is in the peripheral mode. In other words, the wireless connecting unit 112 has data broadcasting capabilities, and the wireless connecting unit 112 cannot actively connect to other electronic devices, wherein the wireless connecting unit 112 can be passively connected to other electronic devices. The storage unit 114 can store related data, such as the identification data corresponding to the first electronic device 110. The controller 116 can control related operations of hardware and software in the first electronic device 110.

It is understood that, in some embodiments, the first electronic device 110 can further comprise at least one physical key (not shown in FIG. 2). The controller 116 can determine whether the physical key is pressed or not, and accordingly perform related processes. In some embodiments, the first electronic device 110 can further comprise at least one sensor (not shown in FIG. 2) for detecting a motion and/or a posture of the first electronic device 110. It is understood that, in some embodiments, the sensor may be an accelerometer for generating information of velocity and displacement when the device moves. In some embodiments, the sensor may be a Gyro sensor for generating information of angular acceleration when the device moves. In some embodiments, the motion sensor may be an e-compass for detecting an angle of the device in regard to a geographical direction, such as the direction of the North Pole or the South Pole. It is noted that, the above sensors are only examples of the present application, and the present invention is not limited thereto. Any sensor that can detect the motion can be applied in the present invention. As described, the sensor can detect the posture of the first electronic device 110. It is understood that, in some embodiments, the posture can be the angular information of the first electronic device 110 in regard to at least one reference point. In some embodiments, the posture of the first electronic device 110 can be represented by an angle corresponding to an axis that is vertical to at least one plane of the first electronic device 110 in regard to a specific direction, such as the gravity direction or the geographical direction. In some embodiments, the first electronic device 110 can further comprise at least one sensor (not shown in FIG. 2) for detecting an environmental factor. For example, the sensor may be a temperature sensor for detecting the temperature of an environment where the first electronic device 110 is in. In another example, the sensor may be a pressure sensor for detecting the pressure of an environment where the first electronic device 110 is in. It is noted that, the above sensor are only examples of the present application, and the present invention is not limited thereto.

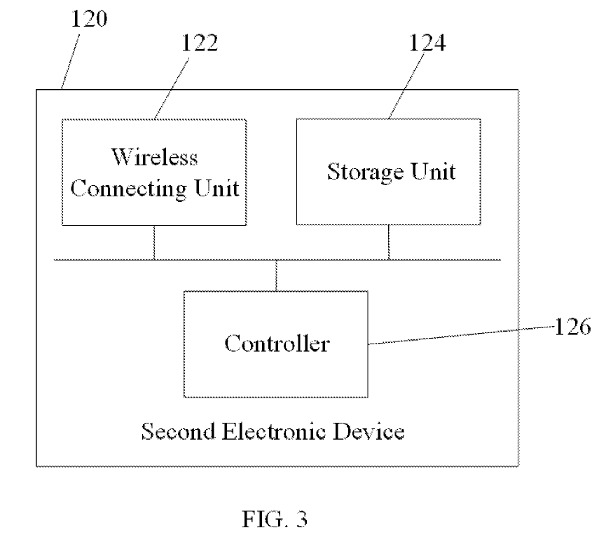

FIG. 3 is a schematic diagram illustrating an embodiment of a second electronic device of the invention. As shown in FIG. 3, the second electronic device 120 comprises a wireless connecting unit 122, a storage unit 124, and a controller 126. The wireless connecting unit 122 can connect to other electronic devices having wireless connecting capabilities via a wireless network, such as Wi-Fi or Bluetooth network. Similarly, in some embodiments, the wireless connecting unit 122 may be a wireless connecting unit implemented with a low-power consumption technology, such as Bluetooth Smart technology. The Bluetooth Smart technology supports two modes: central and peripheral. In the central mode, the wireless connecting unit can receive data from the wireless connecting units of other electronic devices, and can actively connect to other electronic devices. In the peripheral mode, the wireless connecting unit can broadcast signals, such as its identification data. However, the wireless connecting unit cannot actively connect to other electronic devices in the peripheral mode. In some embodiments, the wireless connecting unit 122 is in the central mode. In other words, the wireless connecting unit 122 has data receiving capabilities, and the wireless connecting unit 122 can actively connect to other electronic devices. The storage unit 124 can store related data. The controller 126 can control related operations of hardware and software in the second electronic device 120.

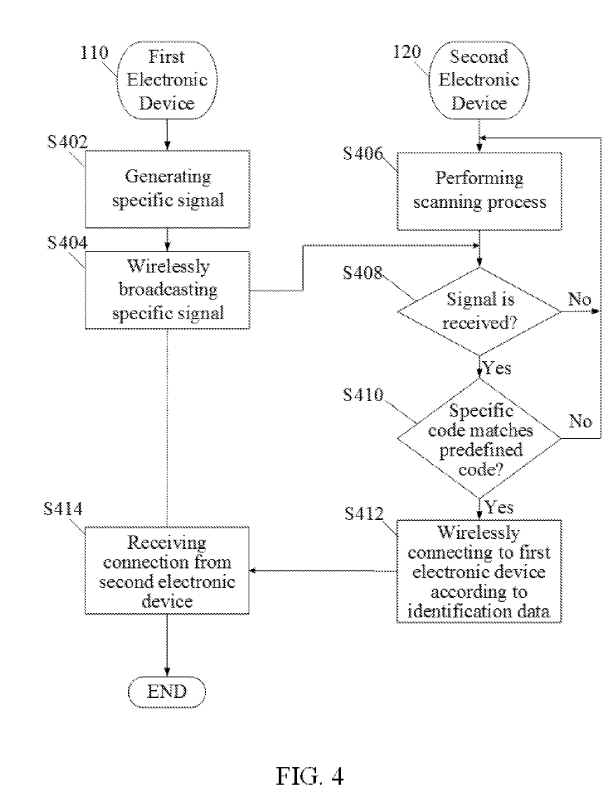

FIG. 4 is a flowchart of an embodiment of a method for managing a connection between electronic devices of the invention. The method for managing a connection between electronic devices can be used in at least two electronic devices having wireless connecting capabilities, such as the first electronic device 110 and the second electronic device 120 in FIG. 1.

In step S402, a first electronic device 110 generates a specific signal, and in step S404, wirelessly broadcasts the specific signal via the wireless connecting unit 112. It is understood that, in some embodiments, the wireless connecting unit 112 may be a wireless connecting unit implemented with a low-power consumption technology, such as Bluetooth Smart technology. The Bluetooth Smart technology supports two modes: central and peripheral. In some embodiments, the wireless connecting unit 112 is in the peripheral mode. In other words, the wireless connecting unit 112 has data broadcasting capabilities, and the wireless connecting unit 112 cannot actively connect to other electronic devices, wherein the wireless connecting unit 112 can be passively connected to other electronic devices. It is noted that, the specific signal comprises a specific code and identification data corresponding to the first electronic device 110.

In step S406, the second electronic device 120 can perform a scanning process via the wireless connecting unit 122, thus determining whether any signal is received. Similarly, in some embodiments, the wireless connecting unit 122 may be a wireless connecting unit implemented with a low-power consumption technology, such as Bluetooth Smart technology. The Bluetooth Smart technology supports two modes: central and peripheral. In some embodiments, the wireless connecting unit 122 is in the central mode. In other words, the wireless connecting unit 122 has data receiving capabilities, and the wireless connecting unit 122 can actively connect to other electronic devices. When no signal is received (No in step S408), the procedure returns to step S406. When a signal, such as the specific signal transmitted by the first electronic device 110 is received via a wireless network (Yes in step S408), in step S410, it is determined whether the specific code in the specific signal matches a predefined code in the second electronic device 120. When the specific code in the specific signal does not match the predefined code (No in step S410), the procedure returns to step S406. When the specific code in the specific signal matches the predefined code (Yes in step S410), in step S412, the second electronic device 120 wirelessly connects to the first electronic device 110 via the wireless connecting unit 122 according to the identification data in the specific signal. In step S414, the first electronic device 110 wirelessly receives the connection corresponding to the second electronic device 120.

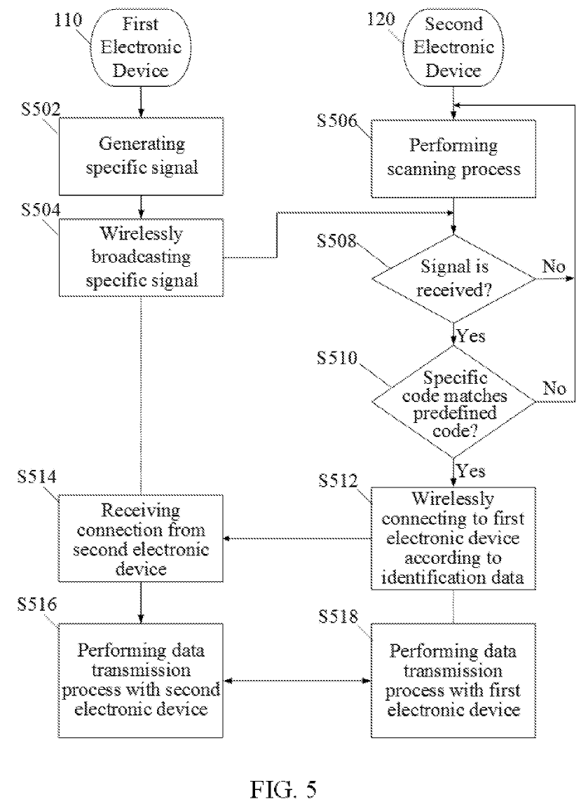

FIG. 5 is a flowchart of another embodiment of a method for managing a connection between electronic devices of the invention. The method for managing a connection between electronic devices can be used in at least two electronic devices having wireless connecting capabilities, such as the first electronic device 110 and the second electronic device 120 in FIG. 1.

In step S502, a first electronic device 110 generates a specific signal, and in step S504, wirelessly broadcasts the specific signal via the wireless connecting unit 112. Similarly, in some embodiments, the wireless connecting unit 112 may be a wireless connecting unit implemented with a low-power consumption technology, such as Bluetooth Smart technology. The Bluetooth Smart technology supports two modes: central and peripheral. In some embodiments, the wireless connecting unit 112 is in the peripheral mode. In other words, the wireless connecting unit 112 has data broadcasting capabilities, and the wireless connecting unit 112 cannot actively connect to other electronic devices, wherein the wireless connecting unit 112 can be passively connected to other electronic devices. It is noted that, the specific signal comprises a specific code and identification data corresponding to the first electronic device 110.

In step S506, the second electronic device 120 can perform a scanning process via the wireless connecting unit 122, thus determining whether any signal is received. Similarly, in some embodiments, the wireless connecting unit 122 may be a wireless connecting unit implemented with a low-power consumption technology, such as Bluetooth Smart technology. The Bluetooth Smart technology supports two modes: central and peripheral. In some embodiments, the wireless connecting unit 122 is in the central mode. In other words, the wireless connecting unit 122 has data receiving capabilities, and the wireless connecting unit 122 can actively connect to other electronic devices. When no signal is received (No in step S508), the procedure returns to step S506. When a signal, such as the specific signal transmitted by the first electronic device 110 is received via a wireless network (Yes in step S508), in step S510, it is determined whether the specific code in the specific signal matches a predefined code in the second electronic device 120. When the specific code in the specific signal does not match the predefined code (No in step S510), the procedure returns to step S506. When the specific code in the specific signal matches the predefined code (Yes in step S510), in step S512, the second electronic device 120 wirelessly connects to the first electronic device 110 via the wireless connecting unit 122 according to the identification data in the specific signal. In step S514, the first electronic device 110 wirelessly receives the connection corresponding to the second electronic device 120. Then, in steps S516 and S518, a data transmission process is performed between the first electronic device 110 and the second electronic device 120. It is understood that, in some embodiments, the data transmission process comprises a data transmission and reception between the first electronic device 110 and the second electronic device 120. In some embodiments, the data transmission volume during the data transmission process is greater than the max transmission limitation of wireless broadcasting.

It is understood that, in some embodiments, the first electronic device 110 can receive an instruction, and generates a specific signal according to the instruction.

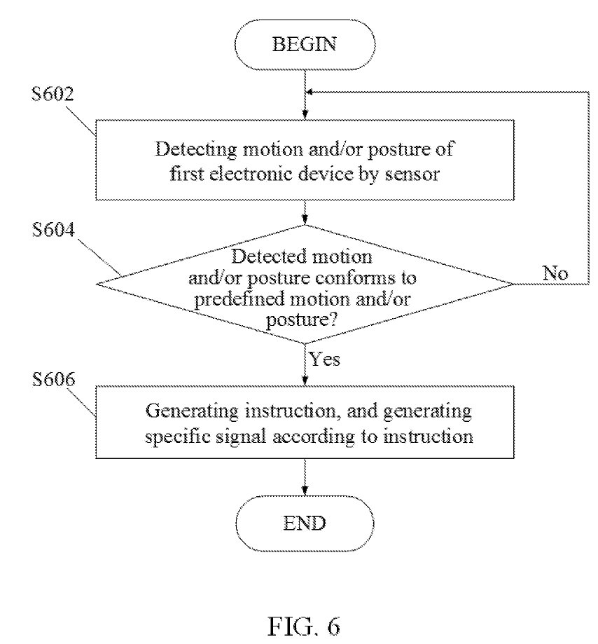

FIG. 6 is a flowchart of an embodiment of a method for generating a specific signal of the invention. In step S602, at least one sensor detects a motion and/or posture corresponding to the first electronic device 110. It is understood that, in some embodiments, the sensor may be an accelerometer for generating information of velocity and displacement when the device moves. In some embodiments, the sensor may be a Gyro sensor for generating information of angular acceleration when the device moves. In some embodiments, the motion sensor may be an e-compass for detecting an angle of the device in regard to a geographical direction, such as the direction of the North Pole or the South Pole. It is noted that, the above sensors are only examples of the present application, and the present invention is not limited thereto. Any sensor that can detect the motion can be applied in the present invention. In step S604, it is determined whether the motion and/or posture of the first electronic device 110 conforms to a predefined motion and/or posture. When the motion and/or posture of the first electronic device 110 does not conform to the predefined motion and/or posture (No in step S604), the procedure returns to step S602. When the motion and/or posture of the first electronic device 110 conforms to the predefined motion and/or posture (Yes in step S604), in step S606, an instruction is generated according to the motion of the first electronic device 110, and a specific signal is generated according to the instruction. As described, the specific signal can comprise a specific code and the identification data corresponding to the first electronic device 110. The specific signal is wirelessly broadcasted by the wireless connecting unit 112.

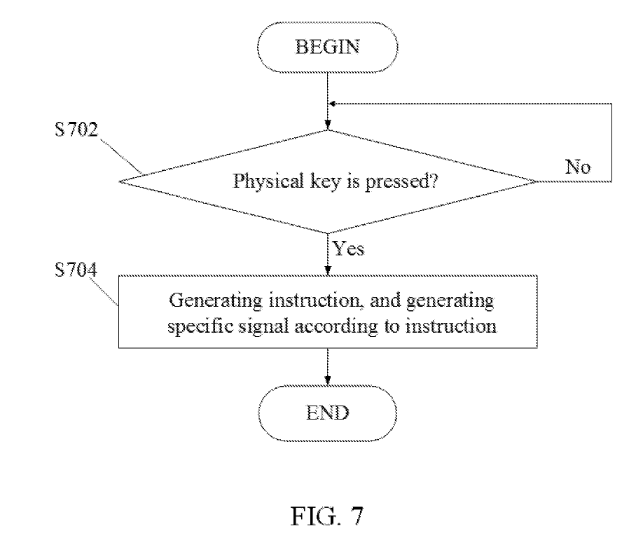

FIG. 7 is a flowchart of another embodiment of a method for generating a specific signal of the invention. In step S702, it is determined whether at least one physical key of the first electronic device 110 is pressed or not. When the physical key is not pressed (No in step S702), the procedure remains at step S702. When the physical key is pressed (Yes in step S702), in step S704, an instruction is generated according to the pressed physical key, and a specific signal is generated according to the instruction. Similarly, the specific signal can comprise a specific code and the identification data corresponding to the first electronic device 110. The specific signal is wirelessly broadcasted by the wireless connecting unit 112.

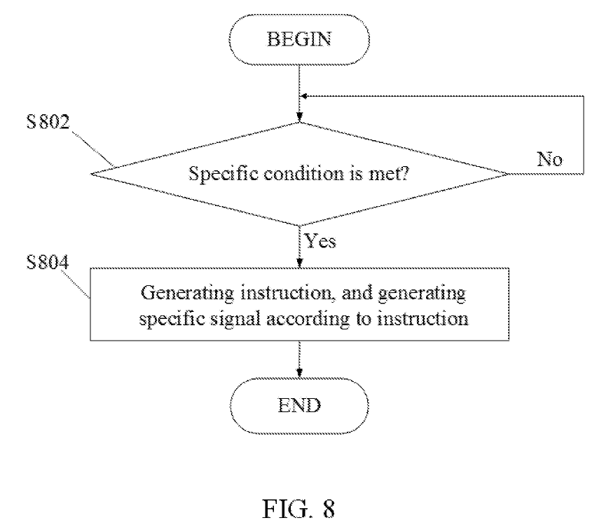

FIG. 8 is a flowchart of another embodiment of a method for generating a specific signal of the invention. In step S802, the first electronic device 110 determines whether a specific condition is met or not. It is noted that, the specific condition may vary according to different requirements and applications. For example, the specific condition may be a specific time. When the current time reaches a specific time, the specific condition is met. In another example, the specific condition may be a specific region. When the location of the first electronic device 110 is within the specific region, the specific condition is met. In another example, a sensor of the first electronic device 110 can detect related data, such as an environmental factor, and it is determined whether the detected data conforms to a specific threshold value or a specific state. When the detected data conforms to the specific threshold value or the specific state, the specific condition is met. For example, the sensor may be a temperature sensor for detecting the temperature of an environment where the first electronic device 110 is in. In another example, the sensor may be a pressure sensor for detecting the pressure of an environment where the first electronic device 110 is in. It is noted that, the above sensors are only examples of the present application, and the present invention is not limited thereto. When the specific condition is not met (No in step S802), the procedure remains at step S802. When the specific condition is met (Yes in step S802), in step S804, an instruction is generated, and a specific signal is generated according to the instruction. Similarly, the specific signal can comprise a specific code and the identification data corresponding to the first electronic device 110. The specific signal is wirelessly broadcasted by the wireless connecting unit 112.

Therefore, the methods and systems for managing a connection between electronic devices of the present invention can drive an electronic device to connect to a specific electronic device according to a request generated by the specific electronic device, so that the data transmission between electronic devices can occur in real-time. Since the electronic devices do not need to maintain the connection while waiting for data transmission, the system resources, such as power for maintaining the connection can be significantly reduced.

Methods for managing a connection between electronic devices may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A method for managing a connection between electronic devices, comprising:
generating a specific signal by a first electronic device, wherein the specific signal comprises a specific code and identification data corresponding to the first electronic device;
wirelessly broadcasting the specific signal via a wireless connecting unit of the first electronic device;
wirelessly receiving the specific signal via a wireless connecting unit of a second electronic device;
determining whether the specific code in the specific signal matches a predefined code by the second electronic device; and
wirelessly connecting to the first electronic device by the second electronic device according to the identification data in the specific signal when the specific code in the specific signal matches the predefined code.

2. The method of claim 1, wherein the wireless connecting unit of the first electronic device is in a peripheral mode, and the wireless connecting unit of the second electronic device is in a central mode, in which the wireless connecting unit has data broadcasting capabilities, and the wireless connecting unit cannot actively connect to other electronic devices in the peripheral mode, and the wireless connecting unit has data receiving capabilities, and the wireless connecting unit can actively connect to other electronic devices in the central mode.

3. The method of claim 1, wherein the first electronic device receives an instruction, and generates the specific signal according to the instruction, in which the first electronic device comprises at least one sensor for detecting a motion or posture corresponding to the first electronic device, and the first electronic device generates the instruction according to the detected motion or posture.

4. The method of claim 1, wherein the first electronic device receives an instruction, and generates the specific signal according to the instruction, in which the first electronic device comprises at least one physical key, and the first electronic device generates the instruction when the physical key is pressed.

5. The method of claim 1, wherein the first electronic device receives an instruction, and generates the specific signal according to the instruction, in which the first electronic device determines whether a specific condition is met, and the first electronic device generates the instruction when the specific condition is met.

6. The method of claim 5, wherein the first electronic device comprises at least one sensor for detecting an environment factor, and the first electronic device generates the instruction when the specific condition is met based on the environment factor.

7. The method of claim 1, wherein after the second electronic device connects to the first electronic device via the wireless network, a data transmission process is performed between the first electronic device and the second electronic device.

8. A system for managing a connection between electronic devices, comprising:
a first electronic device generating a specific signal, wherein the specific signal comprises a specific code and identification data corresponding to the first electronic device, and wirelessly broadcasting the specific signal via a wireless connecting unit; and
a second electronic device wirelessly receiving the specific signal via a wireless connecting unit, determining whether the specific code in the specific signal matches a predefined code by the second electronic device, and wirelessly connecting to the first electronic device according to the identification data in the specific signal when the specific code in the specific signal matches the predefined code.
